(19) United States
(12) Patent Application Publication
(10) Pub. No.: US 2006/0088052 A1
(43) Pub. Date: Apr. 27, 2006

(54) Decentralized method for generating an MPEG-2 multiprogram transport stream

(76) Inventors: Martin H. Sauser JR., Atlanta, GA (US); James Steven Pawlyk, Maplewood, NJ (US)

Correspondence Address: NEEDLE & ROSENBERG, P.C., SUITE 1000, 999 PEACHTREE STREET, ATLANTA, GA, 30309-3915, US

(21) Appl. No.: 11/260,529

(22) Filed: Oct. 27, 2005

Related U.S. Application Data
(60) Provisional application No. 60/622,049, filed on Oct. 27, 2004.

(51) Int. Cl. H04J 3/16

(52) U.S. Cl. 370/466

(57) ABSTRACT

Methods, systems, and apparatus for generating a multi-program transport stream comprising generating an empty bitstream comprising null packets, providing the empty bitstream to a first contributor wherein the first contributor replaces a null packet with a program packet resulting in a modified bitstream, and providing the modified bitstream to a second contributor. Also provided are methods for back channel management, contributor clock synchronization, and generating a contributor identification map.

### CROSS REFERENCE TO RELATED PATENT APPLICATIONS

This application claims priority to U.S. Provisional Application No. 60/622,049 filed Oct. 27, 2004, herein incorporated by reference in its entirety.

### BACKGROUND OF THE INVENTION

Generation of an MPEG-2 Multiprogram Transport Stream (MPTS) involves the use of a multiplexer. An MPEG-2 multiplexer inputs a number of Single Program Transport Streams (SPTS) and/or multiple MPTS and outputs an MPTS. The multiplexer has a packet scheduling algorithm that allocates each output transmission opportunity to one of the input streams, taking into account the Constant Bit Rate (CBR) or Variable Bit Rate (VBR) characteristics of the input stream. The input streams contain Program Reference Clocks (PCR) values whose validity depends on the exact timing of packet transmission. If the delay through the multiplexer is not constant the multiplexer must recalculate the PCR values to avoid introducing PCR jitter. This recalculation is expensive; the multiplexer uses a clock recovery PLL to derive a clock signal from each stream's input PCR to generate a new PCR value for each output stream.

### SUMMARY OF THE INVENTION

Disclosed are methods, systems, and apparatus for creating an MPEG-2 Multi Program Transport Stream (MPTS) from independently generated Single Program Transport Streams (SPTS) in encoders without using a multiplexer. A method for generating a multi-program transport stream comprising generating an empty bitstream comprising null packets, providing the empty bitstream to a first contributor wherein the first contributor replaces a null packet with a program packet resulting in a modified bitstream, and providing the modified bitstream to a second contributor. A system for generating a multi-program transport stream comprising a null packet generator wherein the null packet generator generates a bitstream comprising null packets and a contributor operatively coupled to the null packet generator wherein the contributor receives the bitstream and replaces a null packet with a program packet. An apparatus for generating a multi-program transport stream comprising a means for receiving a bitstream having a null packet, a processor configured to identify packet transmission opportunities in the bitstream, and a packet generator operatively coupled to the processor, wherein the packet generator is configured to replace a null packet in a received bitstream with a program packet when a packet transmission opportunity is identified by the processor. Also provided are methods for back channel management, contributor clock synchronization, and generating a contributor identification map.

Additional advantages of the invention will be set forth in part in the description which follows or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain the principles of the invention.

FIG. 1 shows an exemplary block diagram of a system capable of implementing the method of the current invention.

FIG. 2 illustrates a flow diagram indicating an exemplary Error Manager module 107 state machine.

FIG. 3 illustrates a bitstream 301 that represents exemplary ideal transmissions of contributors.

FIG. 4 illustrates a blockaded bit stream 401.

FIGS. 5A and B illustrate an exemplary operating environment.

FIG. 6 illustrates an exemplary CID map and a bitstream with CID labeled packets.

FIG. 7 illustrates an exemplary CID Map creation method.

FIG. 8 illustrates an exemplary back channel implementation.

FIG. 9 illustrates exemplary steps in a method for generating a multi-program transport stream.

FIG. 10 illustrates exemplary steps in a method for generating a multi-program transport stream.

FIG. 11 illustrates exemplary steps in a method for generating a multi-program transport stream.

FIG. 12 illustrates exemplary steps in a method for controlling transmission rates of a contributor.

FIG. 13 illustrates exemplary steps in a method for controlling transmission rates of a contributor.

FIG. 14 illustrates exemplary steps in a method for generating a CID map.

FIG. 15 illustrates exemplary steps in a method for back channel management.

FIG. 16 illustrates exemplary steps in a method for synching contributors.

FIG. 17 illustrates exemplary steps in a method for synching contributors.

### DETAILED DESCRIPTION OF THE INVENTION

Before the present methods and systems are disclosed and described, it is to be understood that this invention is not limited to specific synthetic methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Thus, for example, reference to “an encoder” includes mixtures of encoders, reference to “an encoder” includes mixtures of two or more such encoders, and the like.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

I. MPEG Streams

The output of a single MPEG audio or video coder is called an elementary stream. An elementary stream is an endless near real-time signal. For convenience, the elementary stream may be broken into data blocks of manageable size, forming a packetized elementary stream (PES). These data blocks need header information to identify the start of the packets and must include time stamps because packetizing disrupts the time axis.

One video PES, a number of audio PES, and other PES including teletext can be combined to form a program stream, provided that all of the coders are locked to a common clock. Time stamps in each PES can be used to ensure synchronization between video and audio. Program streams have variable-length packets with headers.

For transmission and digital broadcasting, several programs and their associated PES can be combined, or multiplexed, into a single transport stream. A transport stream differs from a program stream in that the PES packets are further subdivided into short fixed-size packets and in that multiple programs encoded with different clocks can be carried. This is possible because a transport stream has a program clock reference (PCR) mechanism that allows transmission of multiple clocks, one of which is selected and regenerated at the decoder. A single program transport stream (SPTS) is also possible and this may be found between a coder and a multiplexer. Since a transport stream can genlock the decoder clock to the encoder clock, the SPTS is more common than the Program Stream. In transmission, the decoder has to recreate the time base at the encoder or it will suffer overflow or underflow. Thus, a transport stream uses program clock reference (PCR), whereas a program stream has no need for the program clock.

A transport stream is more than just a multiplex of audio and video PES. In addition to the compressed audio, video and data, a transport stream includes metadata describing the bit stream. This includes the program association table (PAT) that lists every program in the transport stream. Each entry in the PAT points to a program map table (PMT) that lists the elementary streams making up each program. Some programs will be open, but some programs may be subject to conditional access (encryption) and this information is also carried in the metadata.

The transport stream can comprise fixed-size data packets, each containing 188 bytes. Each packet carries a program identifier code (PID). Packets in the same elementary stream all have the same PID, so that the decoder (or a demultiplexer) can select the elementary stream(s) it wants and reject the remainder. Packet continuity counts ensure that every packet that is needed to decode a stream is received. An effective synchronization system is needed so that decoders can correctly identify the beginning of each packet and deserialize the bit stream into words.

A. Program Streams

For a given picture quality, the data rate of compressed video will vary with picture content. A variable bit rate channel will give the best results. In transmission, most practical channels are fixed and the overall bit rate is kept constant by the use of stuffing (meaningless data).

A program stream is a PES packet multiplex that carries several elementary streams that were encoded using the same master clock or system time clock (STC). This stream might be a video stream and its associated audio streams, or a multichannel audio-only program. The elementary video stream is divided into access units (AUs), each of which contains compressed data describing one picture. These pictures are identified as I, P, or B and each carries an AU number that indicates the correct display sequence. One video AU becomes one program-stream packet. In video, these packets vary in size. For example, an I-picture packet will be much larger than a B-picture packet. Digital audio access units are generally of the same size and several are assembled into one program-stream packet. These packets should not be confused with transport-stream packets that are smaller and of fixed size. Video and audio AU boundaries rarely coincide on the time axis, but this lack of coincidence is not a problem because each boundary has its own time-stamp structure.

B. Transport Streams

A transport stream is more than a multiplex of many PES packets. In program streams, time stamps are sufficient to recreate the time axis because the audio and video are locked to a common clock. For transmission down a data network over distance, there is an additional requirement to recreate the clock for each program at the decoder. This requires an additional layer of syntax to provide PCR signals.

A Transport Stream can carry many different programs and each program may use a different compression factor and a bit rate that can change dynamically even though the overall bit rate stays constant. This behavior is called statistical multiplexing and it allows a program that is handling difficult material to borrow bandwidth from a program handling easy material. Each video PES can have a different number of audio and data PESs associated with it.

The transport layer converts the PES data into small packets of constant size (adding stuffing bits if necessary) that are self-contained. When these packets arrive at the decoder, there may be jitter in the timing. Time stamps are part of the solution, but they only work if a stable clock is available. The transport stream must contain further data allowing the re-creation of a stable clock.

The operation of digital video equipment is heavily dependent on the distribution of a stable system clock for synchronization. In video production, genlocking is used, but over long distances, the distribution of a separate clock is not practical. In a transport stream, the different programs may have originated in different places that are not necessarily synchronized. As a result, the transport stream has to provide a separate means of synchronizing for each program.

This additional synchronization method is called a PCR and it recreates a stable reference clock that can be divided down to create a time line at the decoder, so that the time stamps for the elementary streams in each program become useful. Consequently, one definition of a program is a set of elementary streams sharing the same timing reference. In a single program transport stream (SPTS), there will be one PCR channel that recreates one program clock for both audio and video. The SPTS is often used as the communication between an audio/video coder and a multiplexer.

i. Packets

The size of a transport packet is a constant 188 bytes and is divided into a header and a payload. A minimum header is 4 bytes. In this header, the most important information is the sync byte. This byte is recognized by the decoder so that the header and the payload can be deserialized. Packets also contain a transport error indicator. This indicator is set if the error correction layer above the transport layer is experiencing a raw-bit error rate (BER) that is too high to be correctable. It indicates that the packet may contain errors. Packets also contain packet identification (PID). This thirteen-bit code is used to distinguish between different types of packets. Packets also contain a continuity counter. This four-bit value can be incremented by a multiplexer as each new packet having the same PID is sent. It is used to determine if any packets are lost, repeated, or out of sequence.

In some cases, more header information is needed, and if this is the case, the adaptation field control bits are set to indicate that the header is larger than normal. When this happens the extra header length is described by the adaptation field length code. Where the header is extended, the payload becomes smaller to maintain constant packet length.

ii. Program Clock Reference (PCR)

The encoder used for a particular program can have a 27-MHz program clock. In the case of an SDI (serial digital interface) input, the bit clock can be divided by 10 to produce the encoder program clock. Where several programs originate in the same production facility, it is possible that they will all have the same clock. In case of an analog video input, the H-sync period can be multiplied by a constant in a PLL (phase-locked loop) to produce 27 MHz.

A phase-locked loop (PLL) is an electronic circuit with a voltage- or current-driven oscillator that is constantly adjusted to match in phase (and thus lock on) the frequency of an input signal. In addition to stabilizing a particular communications channel (keeping it set to a particular frequency), a PLL can be used to generate a signal, modulate or demodulate a signal, reconstitute a signal with less noise, or multiply or divide a frequency. PLLs are more commonly used for digital data transmission, but can also be designed for analog information.

The adaptation field in the packet header is used periodically to include the PCR code that allows generation of a locked clock at the decoder. If the encoder or a remultiplexer has to switch sources, the PCR may have a discontinuity. The continuity count can also be disturbed. This event is handled by the discontinuity indicator, which tells the decoder to expect a disturbance. Otherwise, a discontinuity is an error condition.

PCR is used by the decoder to recreate a remote version of the 27-MHz clock for each program. The encoder clocks drive a constantly running binary counter, and the value of these counters are sampled periodically and placed in the header adaptation fields as the PCR. The PCR is a 42-bit number that is represented by a 33-bit PCR base, plus a 9-bit PCR extension to provide higher resolution. (The PCR base, like the PTS, is a 33-bit number that is a sample of a counter driven by a 90-kHz clock). The packets generated by each encoder are given a different PID. The decoder recognizes the packets with the correct PID for the selected program and ignores others. At the decoder, a voltage controlled oscillator (VCO) generates a nominal 27 MHz clock and this drives a local PCR counter. The local PCR is compared with the PCR from the packet header and the difference is the PCR phase error. This error is filtered to control the VCO that eventually will bring the local PCR count into step with the header PCRs. Heavy VCO filtering ensures that jitter in PCR transmission does not modulate the clock. The discontinuity indicator will reset the local PCR count and, optionally, may be used to reduce the filtering to help the system quickly lock to the new timing.

MPEG requires that PCRs be sent at a rate of at least 10 PCRs per second, whereas DVB specifies a minimum of 25 PCRs per second.

iii. Packet Identification (PID)

A 13-bit field in the transport packet header contains the Packet Identification code (PID). The PID is used by the demultiplexer to distinguish between packets containing different types of information. The transport-stream bit rate must be constant, even though the sum of the rates of all of the different streams it contains can vary. This requirement is handled by the use of null packets. If the real payload rate falls, more null packets are inserted. Null packets always have the same PID, which is 8191 (thirteen ones in the binary representation).

In a given transport stream, all packets belonging to a given elementary stream will have the same PID. The demultiplexer can easily select all data for a given elementary stream simply by accepting only packets with the right PID. Data for an entire program can be selected using the PIDs for video, audio and data streams such as subtitles or teletext. The demultiplexer can correctly select packets only if it can correctly associate them with the elementary stream to which they belong. The demultiplexer can do this task only if it knows what the right PIDs are. This is the function of the PSI.

iv. Program Specific Information (PSI)

PSI is carried in packets having unique PIDS, some of which are standardized and some of which are specified by the program association table (PAT), conditional access table (CAT) and the transport stream description table (TSDT). These packets must be included periodically in every transport stream. The PAT always has a PID of 0, the CAT always has a PID of 1, and the TSDT always has a PID of 2. These values and the null-packet PID of 8191 are the only PIDs fixed by the MPEG standard. The demultiplexer must determine all of the remaining PIDs by accessing the appropriate tables. However, there are some constraints in the use of PIDs in ATSC and DVB. In this respect (and in some others), MPEG and DVB/ATSC are not fully interchangeable. All DVB and ATSC transport stream must be MPEG-2 compliant (ISO/IEC 13818-1), but not all MPEG-2 transport streams will be compliant with the ATSC (A/65A) or DVB (EN 300 468) standards.

The programs that exist in the transport stream are listed in the program association table (PAT) packets (PID=0) that carries the PID of each PMT packet. The first entry in the PAT, program 0, is reserved for network data and contains the PID of network information table (NIT) packets. Usage of the NIT is optional in MPEG-2, but is mandatory in DVB.

The PIDs for entitlement control messages (ECM) and entitlement management messages (EMM) are listed in the conditional access table (CAT) packets (PID=1).

PIDs of the video, audio, and data elementary streams that belong in the same program are listed in the Program Map Table (PMT) packets. Each PMT packet normally has its own PID, but MPEG-2 does not mandate this. The program number within each PMT will uniquely define each PMT.

The present invention may be understood more readily by reference to the following detailed description of preferred embodiments of the invention and the Examples included therein and to the Figures and their previous and following description.

Disclosed herein is a method for generating an MPTS. The MPTS can be generated initially as an ‘empty’ transport stream. The ‘empty’ transport stream can comprise Null Packets with a data rate sufficient to have spaces for each contributor that is contributing to the MPTS to insert a SPTS into the transport stream. This method allows each contributor to know its packet transmission time and prevents a downstream SPTS from changing the transport time of previously transmitted packets. This permits forgoing the use of a multiplexer to re-calculate the transmission times of the packets in the stream.

II. Operating Environment

This method can be used and has been shown to work in a variety of physical configurations. It can be used, for example, in stand alone encoders separated by a 10 bit scrambled ASI (Asynchronous Serial Interface) link, in single systems creating multiple bit streams connected through an 8 bit parallel bus, and the like. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment. As used herein, a contributor can refer to an MPEG encoder. As used herein, a cascade refers to a series of contributors, operatively connected wherein one contributor is a Master Contributor and can contain a Null Packet Generator. Additionally, the Null Packet Generator can be a device external to the Master Contributor. The method is applicable to both Constant Bit Rate (CBR) and Variable Bit Rate (VBR) transport streams.

A. System Clocks

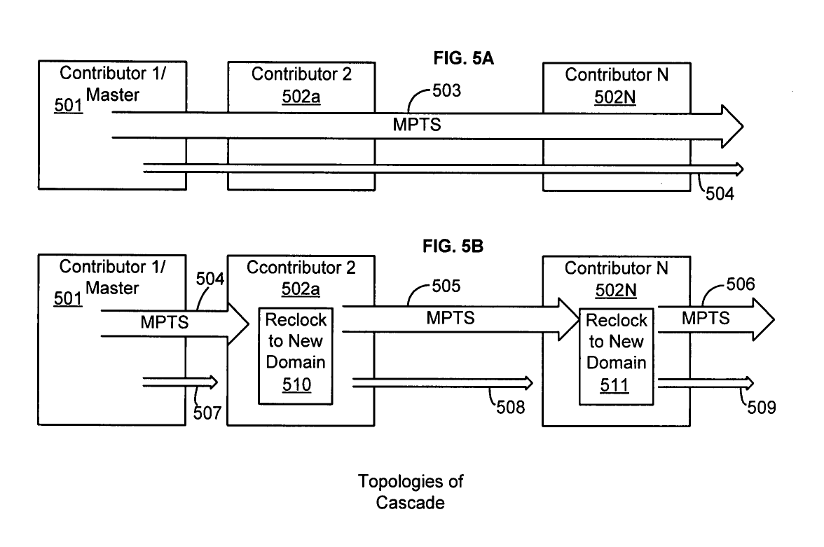

As shown in FIG. 5A, a Master Contributor can generate a 27 Mhz clock that is used at its output to generate a 270 Mhz output clock. All other clocks in the cascade can be derived from this clock, so that all of the clocks in the cascade system are locked to a single clock. Under some circumstances this may generate an accumulation of unacceptable noise in the clock signal especially in contributors later in the chain. In this circumstance, as shown in FIG. 5B, each downstream contributor 502a-N can re-clock (510, 511) the transport stream (504, 505, 506) it receives from the previous contributor in the chain to its own internal clock (507, 508, 509). However, re-clocking the input stream to a clock that is not identical to the original clock creates a slight timing error. To account for this error K28.5 stuffing bytes characters can be added or deleted in between packets. These characters can be added or deleted in such a way that the small timing variations in the system do not accumulate to a degree that a traditional multiplexer would be needed in the system.

To add and delete stuffing bytes the input asi transport stream can be fed into a first in first out data buffer (FIFO) where data is input into the FIFO at the input clock rate and removed from the FIFO at the output clock rate. The FIFO can be allowed to fill to the half-way point before outputting data. During operation the buffer fullness can be monitored, and the positions between valid transport packets in the stream can be located. In portions of the transport stream between valid packets the buffer fullness can be compared against an empty level value and full level value. If the level falls below the empty level, a single stuffing byte can be prevented from clocking out of the FIFO, (essentially writing a single extra byte into the data stream). If the full level is exceeded the clocking of a single stuffing byte into the FIFO can be suppressed, which has the effect of dropping a single byte from the input stream.

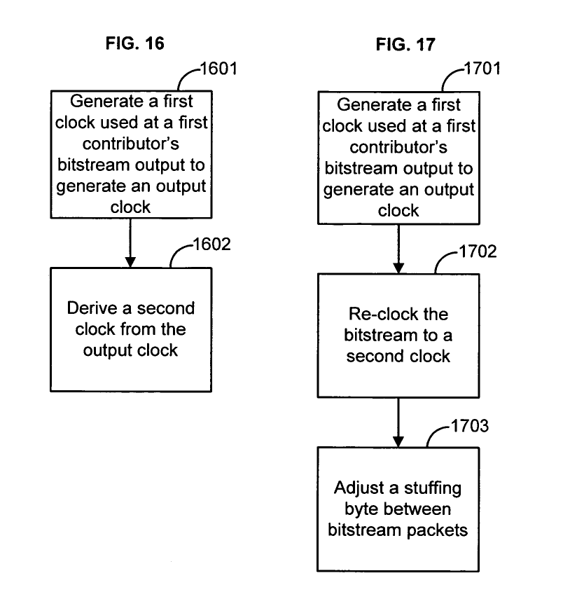

FIG. 16 illustrates exemplary steps in a method for synching contributors comprising generating, by a first contributor, a first clock used at the first contributor's bitstream output to generate an output clock at block 1601 and deriving, by a second contributor, a second clock from the first contributor output clock at block 1602.

FIG. 17 illustrates exemplary steps in a method for synching contributors comprising generating, by a first contributor, a first clock used at the first contributor's bitstream output to generate an output clock at block 1701. Re-clocking, by a second contributor, the bitstream to a second clock internal to the second contributor at block 1702. Adjusting a stuffing byte character between bitstream packets at block 1703.

B. System

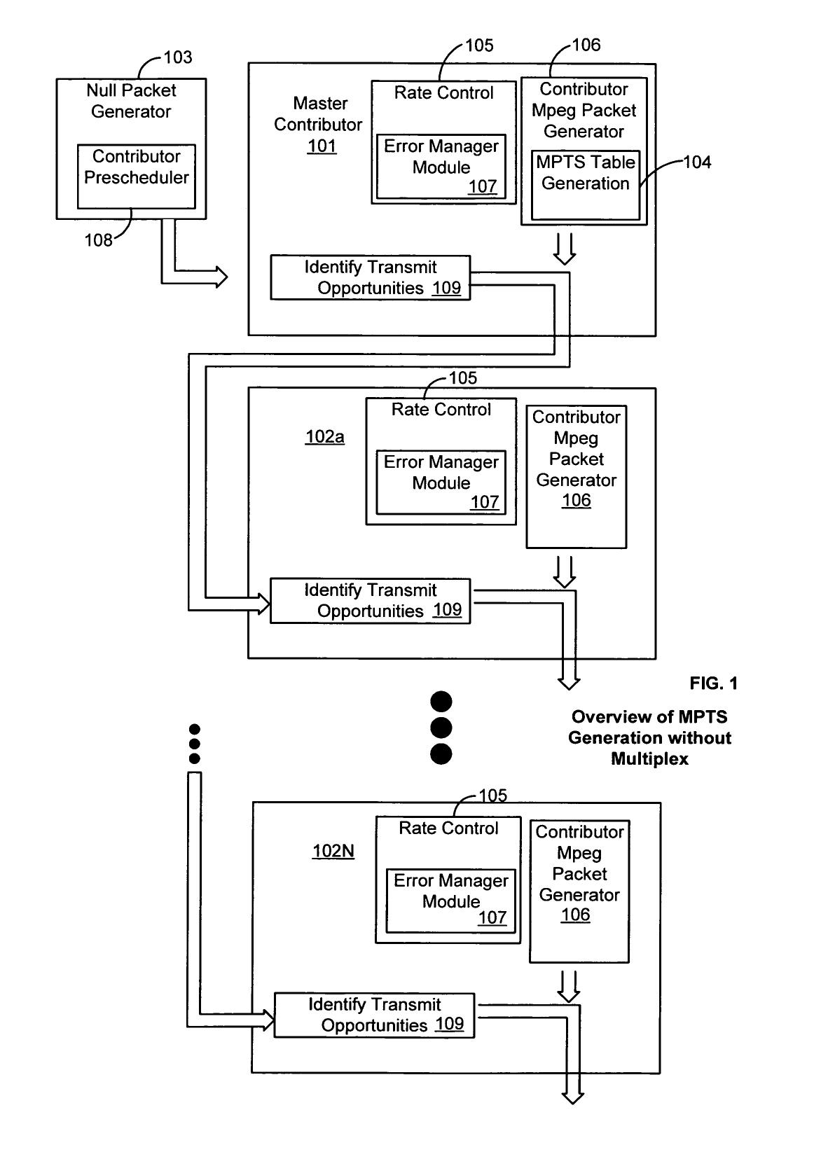

FIG. 1 shows an exemplary block diagram of a system capable of implementing the method of the current invention. It should be noted that the simplest case of one contributor (the Master Contributor 101) is suitable to use as a single MPEG-2 encoder. This design allows the same system components to be used for either a single encoder or a cascade. A Master Contributor 101 can utilize an MPTS Table Generator 104 to generate various tables (PAT, SDT etc) that have information relevant to all of the contributors 102a-N in the system By way of example, and not limitation, the Master Contributor 101 can be provided information about downstream contributors 102a-N either through an operator entering information into the Master Contributor 101, or a back channel can be used to send relevant information to the Master Contributor 101 from the downstream co6ntributors 102a-N.

An empty MPTS is generated by a Null Packet Generator 103 which produces a stream of Null Packets at the system MPTS rate. The Null Packet Generator 103 can be a device external to the Master Contributor 101, or the Null Packet Generator 103 can be integrated into the Master Contributor 101. The empty MPTS is transmitted from the Null Packet Generator 103 to the Master Contributor 101. The contributors described herein can use any means known in the art for receiving an MPTS. Each contributor has an encoder process, referred to as a Contributor MPEG Packet Generator 106, which generates an SPTS at a constant bit rate. Each contributor inputs the MPTS containing Null Packets from the previous contributor at a higher bit rate than the generated SPTS. Each contributor detects Null Packets in the received MPTS that are within the contributor's approximate transmit time as calculated by a rate control module 105. The contributor replaces unused Null Packets with Program Packets and time stamps them during transmission. Null packets carry no information, as such they can be replaced by Program Packets with no loss of information. Since the total amount and rate of packets in the system is preserved, the system maintains constant delay and prevents the need for PCR recalculation.

The ‘empty’ transport stream method requires each contributor to estimate a reasonable transmit time for each of its packets and for the Null Packet Generator 103 to make sure that there are sufficient empty packets for the contributors and that Null Packets are presented to the contributors before the ideal transmission time. In some circumstances this may require transmission of an unacceptable number of extra Null Packets in the stream (headroom), or equivalently, requiring the MPTS rate to be greater than the sum of the rates of the SPTS being combined by some amount (headroom). Since upstream contributors (contributors between a given contributor and the master) can arbitrarily replace Null packets with Program Packets, the Null packets in the MPTS arriving at a given contributor may be distributed unevenly. Increasing the rate at which the Null Packet Generator emits Null packets produces a more even distribution through a dilution effect, making it more likely that Null packet will coincide with each contributor's transmission times. The efficiency of the system can be increased with the addition of an apparatus to allow contributors that fall slightly behind their assigned rate to briefly increase their transport rate.

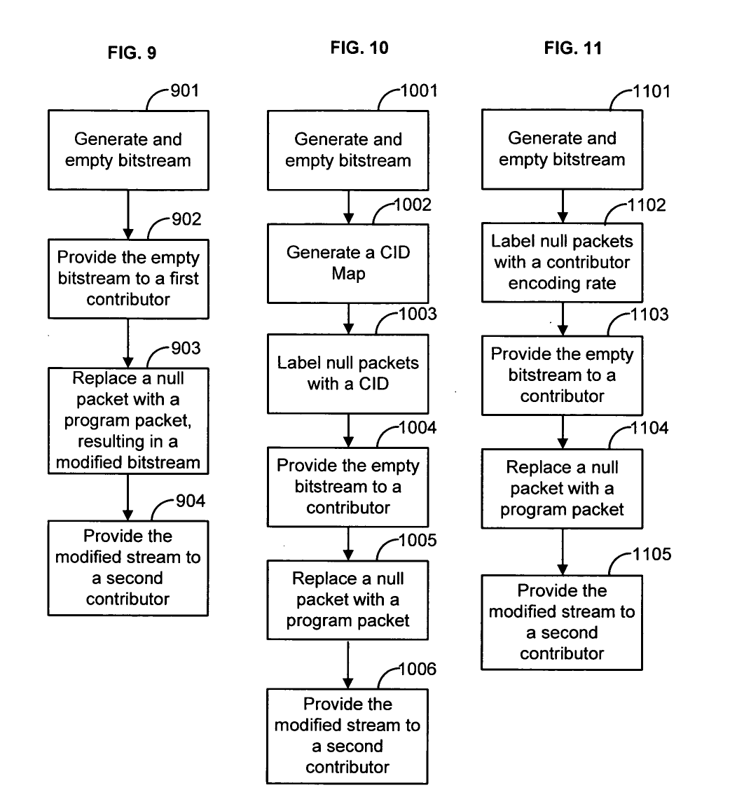

FIG. 9 illustrates exemplary steps in a method for generating a multi-program transport stream comprising generating an empty bitstream comprising null packets at block 901. Providing the empty bitstream to a first contributor at block 902. The first contributor replaces a null packet with a program packet resulting in a modified bitstream at bock 903. Finally, providing the modified bitstream to a second contributor at block 904

FIG. 10 illustrates exemplary steps in a method for generating a multi-program transport stream comprising generating an empty bitstream comprising null packets at block 1001. Generating a CID map comprising contributor ID's at block 1002. Labeling the null packets with a contributor ID at block 1003. Providing the empty bitstream to a first contributor at block 1004. The first contributor replaces a null packet labeled with the contributor ID for the first contributor with a program packet resulting in a modified bitstream at block 1005. Providing the modified bitstream to a second contributor at block 1006.

FIG. 11 illustrates exemplary steps in a method for generating a multi-program transport stream comprising generating an empty bitstream comprising null packets at block 1101. Labeling the null packets with a contributor encoding rate at block 1102. Providing the empty bitstream to a first contributor at block 1103. The first contributor replaces a null packet labeled with a contributor encoding rate that corresponds to an encoding rate for the first contributor with a program packet resulting in a modified bitstream at block 1104. Providing the modified bitstream to a second contributor at block 1105.

C. Error Manager

An Error Manager module 107 can be added to the rate control module 105 in the form of a transmission throttling mechanism to keep track of how far behind the contributor has fallen, and increase the transmit rate proportionally. If the contributor has fallen behind by one packet, the transmission throttling mechanism in the rate control module 105 is disabled for the transmission of a single packet; if the contributor falls behind by two packets the transmission throttling mechanism in the rate control module 105 is disabled during two packet transmissions and so on. The Error Manager module 107 can have a maximum threshold value. Reaching this threshold indicates that there has been a fundamental system configuration error (i.e.: the MPTS rate is set too low), or there has been a fundamental system failure. The threshold value can depend on the amount of memory available to store packets awaiting transmission, and the maximum displacement between ideal and actual packet transmission times that can be tolerated. Threshold values between 5 and 10 have been found to work well. Reaching the threshold can cause an automatic system recovery procedure, for example, a restart, a request for operator intervention, and the like. The Error Manager module 107 can also be used to signal that a contributor is allowed to replace Packets other than the Null Packets created by the Null Packet Generator 103. This is especially useful in systems that use a Null Packet Scheduling Mechanism.

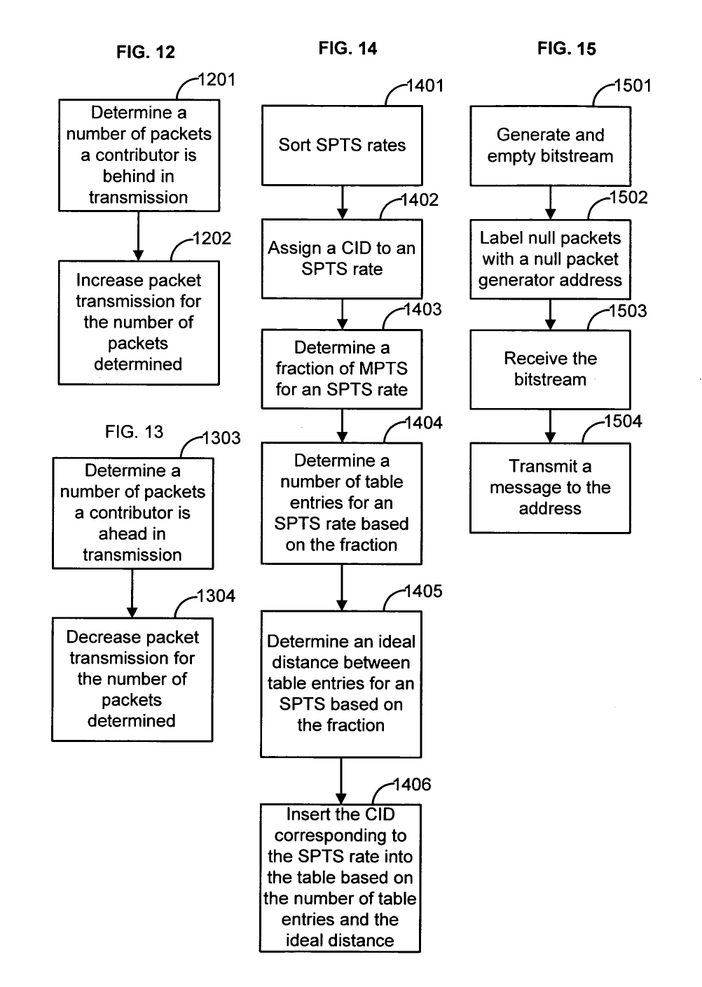

FIG. 12 illustrates exemplary steps in a method for controlling transmission rates of a contributor comprising determining a number of packets a contributor is behind in transmission at block 1201. Increasing packet transmission in the contributor for the number of packets determined at block 1202.

FIG. 13 illustrates exemplary steps in a method for controlling transmission rates of a contributor comprising determining a number of packets a contributor is ahead in transmission at block 1301. Decreasing packet transmission in the contributor for the number of packets determined at block 1302.

The Identify Transmit Opportunities 109 block can identify Null Packets suitable for substitution by a Program Packet. This can be accomplished by identifying start characters in the input asi input transport stream (0x47) and then looking for the 13 bit Null Packet PID. An apparatus of the invention can use a processor to perform this function.

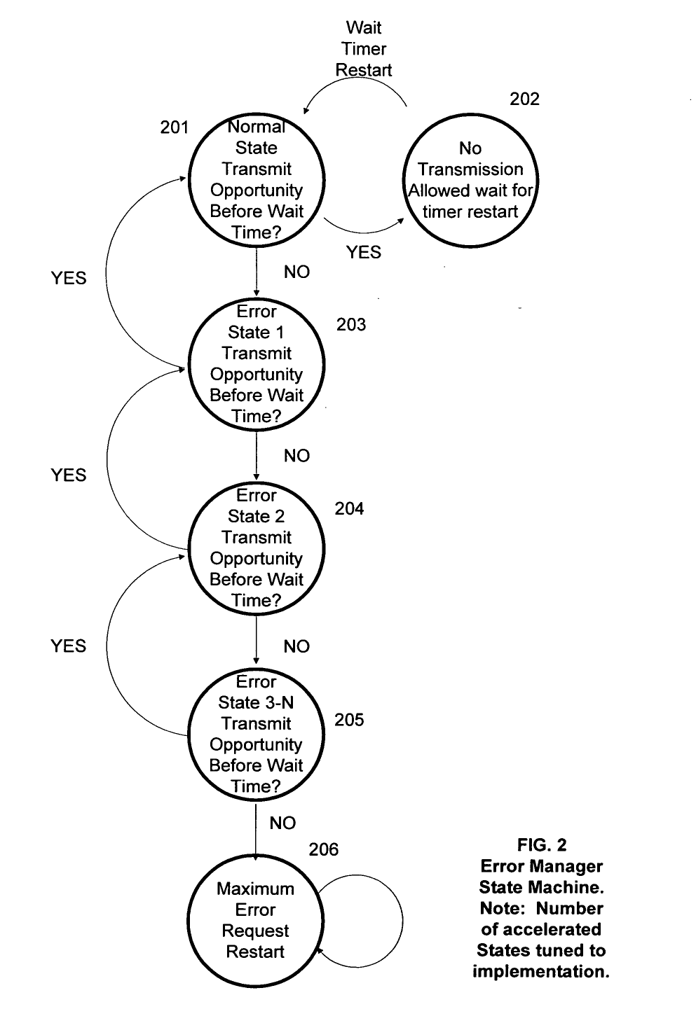

FIG. 2 illustrates a flow diagram indicating an exemplary Error Manager module 107 state machine. During normal operation the process stays in State 201, in this state a wait timer representing a maximum time allowed between contributor packet transmissions for the contributor's SPTS rate can be monitored. If a packet is transmitted before the wait time has elapsed, the process transitions to State 202 where no packet transmissions are allowed. When the wait timer restarts (rollover) the process transitions back to State 201. In this way the contributor throttles packet transmissions even if there are extra opportunities (overprovisoned) in the MPTS.

If the wait timer runs out before a packet has been transmitted the process transitions to State 203. State 203 monitors the wait timer and transmit opportunities. If a packet is transmitted, there is a transition back to State 201, this allows the contributor to transmit an extra packet. State 204 and State 205 represent deeper transitions into the state machine, each deeper state allows one more transmission opportunity. There is no limit to the number (n) of Error States. The number (n) of Error States can be, for example, 4. A Maximum Error State is defined (State 206) which is a terminal state that is reached when the maximum number of Error States n is passed. The Maximum Error state requests system intervention and generally the contributor is restarted.

D. Null Packet Scheduling Mechanism

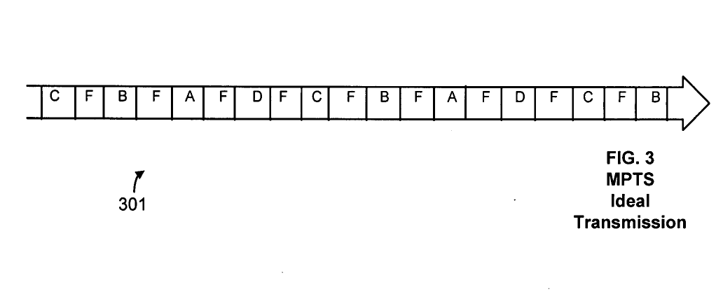

It is possible to further reduce Null Packet Headroom requirements of the basic system by having the Null Packet Generator 103 pre-allocate a schedule for downstream contributors with a Contributor Prescheduler 108. Even with the Error Manager 107, cascade configurations are possible that result in lengthy “blockades” of packets in the MPTS stream. A blockade is defined as a stretch of contiguous packets with no Null Packets. These diabolical cases usually occur when lower-speed contributors are placed upstream of higher speed contributors in a cascade. For example, in a system with an MPTS rate of 10 Mbps, 5 contributors (designated A, B, C, D, E) with SPTS rate of 1 Mbps and a single contributor (designated F) with an SPTS rate of 5 Mbps. The 5 Mbps contributor requires ½ the MPTS bandwidth and ideally should transmit a packet in every other Null Packet in the stream as shown in FIG. 3.

E. Cascade Bitstreams

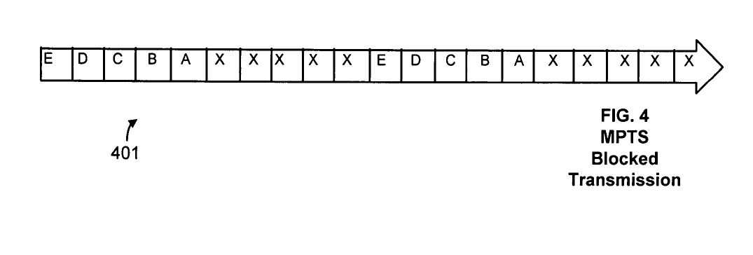

FIG. 3 illustrates a bitstream 301 that represents exemplary ideal transmissions of the 1 Mbps contributors represented by packets labeled A, B, C, D, or E, whereas F represents packets transmitted by the 5 Mbps contributor. If the SMbps contributor is placed first in the cascade (upstream) the arrangement of transmission packets in FIG. 3 will occur naturally. If the 1 Mbps contributors are placed first in the cascade (upstream) a ‘blockade’ like the one shown in FIG. 4 can occur.

FIG. 4 illustrates a bit stream 401 wherein packets labeled X represent transmission opportunities left for the SMbps contributor. In this case the 5 Mbps contributor misses 3 transmit opportunities and must transmit 4 packets in a burst to maintain its transport rate.

This condition can be solved using a 4 state Error Manager 107, but practical systems can be configured to exceed the capacity of reasonably sized error managers.

One solution to this problem is to constrain the rate so a sufficient supply of Null Packets is guaranteed. Setting

$$MPTSRATE \geq [ \begin{matrix}NumberofEncoders \\ inCsacade\end{matrix} ] \times [ \begin{matrix}SPTSRATEof \\ FastestEncoder\end{matrix} ]$$

ensures a sufficient supply of Null Packets because it provides the MPTS rate necessary if all the contributors were running at the same rate. In this case, diabolical patterns do not occur. Assuming that all of the contributors run at the same rate makes planning simple, but results in wasted bandwidth that is unacceptable for many applications.

F. Contributor ID

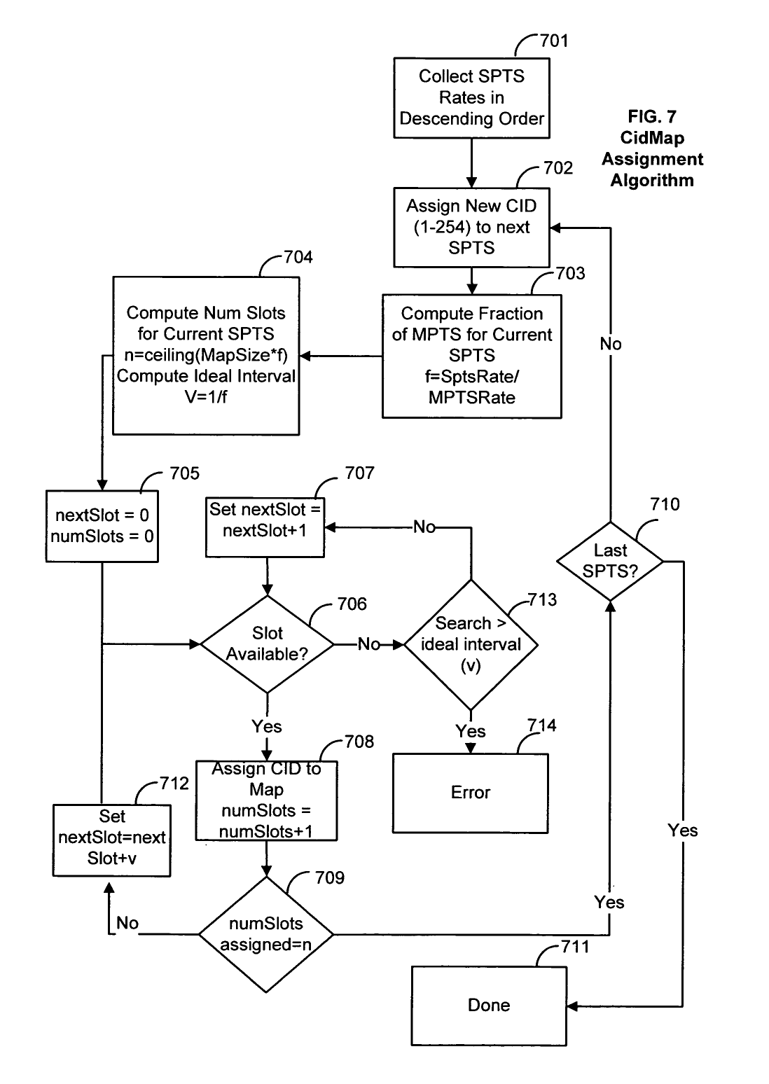

Cascade bandwidth, bandwidth through the linked contributors, can be improved by earmarking, or flagging, Null Packets for use by specific downstream contributors. The Null Packet Generator 103 via the Contributor Prescheduler 108 can accomplish this by storing a one-byte value, called the contributor ID (CID), in the first payload byte of each Null Packet. MPEG states that the payload area of null packets is arbitrary. The present system assumes direct connections between contributors; an assumption inherent in the constant-delay requirements on the bit stream. Either by operator configuration, or by use of optional back channel communication, a CID is assigned to each contributor. The Null Packet Generator 103 is given the bit rate of each contributor's SPTS. The Null Packet Generator 103 uses these rates to create a pattern of CID values (CID Map 601) which is the pattern of optimal Null Packet usage by the downstream contributors. A method for creating the CID Map 601 is illustrated in FIG. 7 and described below. The Null Packet Generator 103 iterates through the CID Map 601, placing one CID byte from the CID Map 601 in each Null Packet that it generates.

i. Optimal Bitstream by CID Map

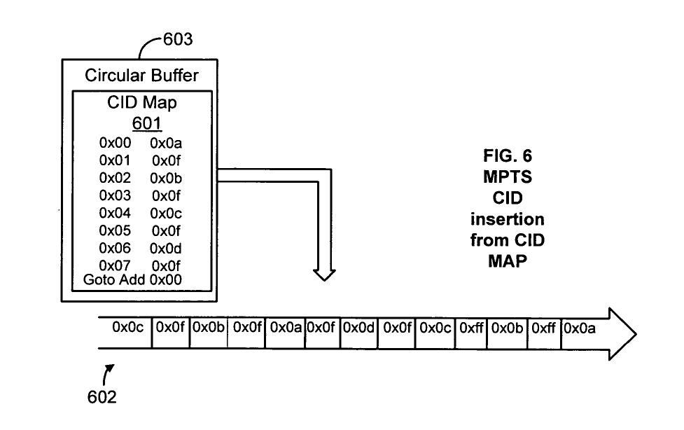

As shown in FIG. 6, by way of example, to create an optimal bitstream 602, a CID Map 601 in the following form can be created: 0x0a, 0x0f, 0x0b, 0x0f, 0x0c, 0x0f, 0x0d, where the hexadecimal numbers 0x0a-0x0f represent the contributors in the example. The packets in the stream are labeled with the number representing the contributor that is scheduled to insert a Program Packet in place of the Null Packet. A circular buffer 603 can be used to store the CID Map 601. A circular buffer 603 allows for rotation through the buffer of the positions where the next data will be read and written. When moving through the buffer, the writer moves forward one step each time it writes, and when it passes the end of the buffer it starts again at the beginning.

The Identify Transmit Opportunities 109 block of FIG. 1 can detect whether Null Packets in the MPTS have the contributor's contributor CID embedded in them. Other Null Packets are ignored and passed through the contributor unchanged for use by downstream contributors. Values can be reserved as ‘wildcards,’ for example, 0x00 and 0xff, and headroom can be added to the MPTS as a conservative engineering measure. The amount of headroom added can be from about 1% to about 15%. For example, headroom added can be approximately 10% of the sum of the contributor SPTS rates. Contributors operating in an ‘Accelerated Transmission’ state of the Error Manager 107 can use these ‘wildcard’ CID packets as well as any extra Null Packets added to the stream by upstream contributors as part of normal operation.

ii. CID Map Generation

FIG. 7 illustrates an exemplary CID Map creation method. A CID map can be an array with an integral number of elements; an array size of 1024 produces good results for many practical systems. To start, all of the elements in the array can be initialized to an unassigned state by setting the elements equal to the value 0xFF, for example. The method begins at block 701 where SPTS rates from the contributors in the system are sorted in descending order, so that the schedule elements representing the fastest SPTS rates are assigned first. The first SPTS rate in the list is assigned a unique CID value in block 702 in the range of, for example, 1-254. At Block 703 the fraction (f) of the MPTS represented by the current SPTS where f=SptsRate/MptsRate is computed. The fraction is used to calculate the number of table entries (n) the current SPTS will need in the table, and the ideal distance (v) between entries in the table for the current SPTS where n=ceiling(MapSize*f), v=1/f and ceiling(x) is the least integer >=x.

The Cid Map is iterated searched for slots to schedule for the current SPTS starting in Block 705 where a search index value nextSlot is set to 0. In Block 706 CID Map element[nextSlot] is examined, if the value at this location in the table is 0xff then the element has not been assigned, so the current CID is assigned to the array element (Block 708) if the element has been assigned a check can be performed to determine if the ideal search interval (nextSlot>v) has passed. If the ideal search range has passed, the process terminates and signals an error (Block 714), otherwise the search index is incremented and the next array element is compared. (Block 707, Block 706). Each time a CID is added to the table, the process checks to see if n slots have been assigned. (Block 709), if n table elements have been assigned, processing for the current SPTS is finished and the process goes to the next SPTS in the list(Block 702) or the process terminates in the done state if the last SPTS has been processed (Block 711).

This method can be enhanced in the following ways. A percentage (ohP) can be added to each contributors SPTS rate for extra overhead.
f=(SPTSRate+(SPTSRate*ohp))/MPTSRate
The search range (sr) can be extended for empty slot detection. In the basic case sr=v. In the extended case, allow sr=m*v. The value m=2 can decrease the number of non-converging patterns without affecting system performance. CID values can be reserved for system use. For example, a CID of 254 can be used to schedule extra packets that for use in back channel communications to guarantee that in a closely provisioned system all the contributors have access to back channel bandwidth.

FIG. 14 illustrates exemplary steps in a method for generating a CID map comprising sorting SPTS rates of contributors in a table at block 1401. Assigning a CID to an SPTS rate at block 1402. Determining a fraction of MPTS for an SPTS rate at block 1403. Determining a number of table entries for an SPTS rate based on the fraction at block 1404. Determining an ideal distance between table entries for an SPTS rate based on the fraction at block 1405. Inserting the CID corresponding to the SPTS rate into the table based on the number of table entries and the ideal distance between table entries at block 1406.

G. Back Channel Management and Configuration

In order to facilitate automatic configuration of the Null Packet Generator 103, and to allow the Contributor Prescheduler 108 to recalculate a schedule on the fly, a ‘back channel’ communication mechanism can be used. In this method the Null Packet Generator 103 imbeds a payload in an unused part of Null Packets. Each contributor reads this payload information, and uses the information to set up a network based communication path. Each contributor is guaranteed to have access to Null Packets with payload information through over provisioning, or through the CID scheduling mechanism.

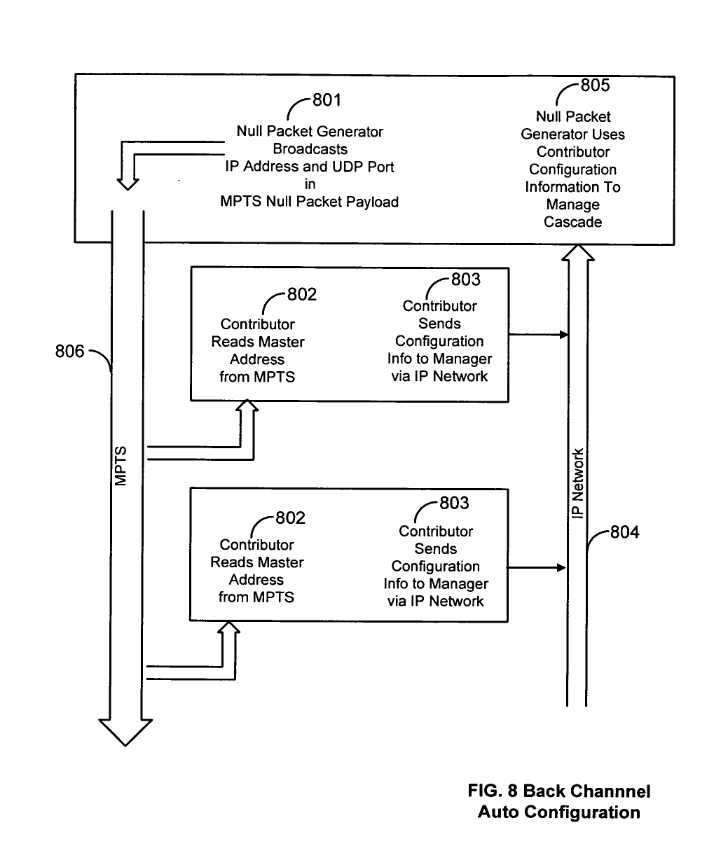

As illustrated in FIG. 8, in a typical configuration, the Null Packet Generator 103 places its IP address and a UDP Port number in the payload section of Null Packets that it generates in the MPTS 806, 801. Each contributor receives this information 802 and sends a registration message to the Null Packet Generator 103 over IP Network 804 containing the contributor's desired bit rate, PMT PID, and other information 803. The Null Packet Generator 103 uses the bit rate information to create the CID Map, 805. The Null Packet Generator 103 uses the PMT PID and program number to generate a Program Map table describing its audio and video streams and includes this PMT in its own SPTS output. The Null Packet Generator 103 can include all of this information in a single convenient display for management purposes. The Null Packet Generator 103 can also use this information to resolve or report system configuration errors.

FIG. 15 illustrates exemplary steps in a method for back channel management comprising generating, by a null packet generator, a bitstream comprising null packets at block 1501. Labeling the null packets with an address of the null packet generator at block 1502. Receiving the bitstream by a contributor at block 1503. Transmitting, by the contributor, a message to the address of the null packet generator wherein the message comprises contributor data at block 1504.

The processing of the disclosed method can be performed by software components. The disclosed method may be described in the general context of computer-executable instructions, such as program modules, being executed by one or more computers or other devices. Generally, program modules include computer code, routines, programs, objects, components, data structures, etc. that perform particular tasks or implement particular abstract data types. The disclosed method may also be practiced in grid-based and distributed computing environments where tasks are performed by remote processing devices that are linked through a communications network. In a distributed computing environment, program modules may be located in both local and remote computer storage media including memory storage devices.

An implementation of the disclosed method may be stored on or transmitted across some form of computer readable media. Computer readable media can be any available media that can be accessed by a computer. By way of example, and not limitation, computer readable media may comprise “computer storage media” and “communications media.” “Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

While this invention has been described in connection with preferred embodiments and specific examples, it is not intended that the scope of the invention be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which this invention pertains.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for generating a multi-program transport stream comprising:
generating an empty bitstream comprising null packets;
providing the empty bitstream to a first contributor wherein the first contributor replaces a null packet with a program packet resulting in a modified bitstream; and
providing the modified bitstream to a second contributor.

2. A method for generating a multi-program transport stream comprising:
generating an empty bitstream comprising null packets;
generating a CID map comprising contributor ID's;
labeling the null packets with a contributor ID;
providing the empty bitstream to a first contributor wherein the first contributor replaces a null packet labeled with the contributor ID for the first contributor with a program packet resulting in a modified bitstream; and
providing the modified bitstream to a second contributor.

3. A method for generating a multi-program transport stream comprising:
generating an empty bitstream comprising null packets;
labeling the null packets with a contributor encoding rate;
providing the empty bitstream to a first contributor wherein the first contributor replaces a null packet labeled with a contributor encoding rate that corresponds to an encoding rate for the first contributor with a program packet resulting in a modified bitstream; and
providing the modified bitstream to a second contributor.

4. A method for controlling transmission rates of a contributor comprising:
determining a number of packets a contributor is behind in transmission; and
increasing packet transmission in the contributor for the number of packets determined.

5. A method for controlling transmission rates of a contributor comprising:
determining a number of packets a contributor is ahead in transmission; and
decreasing packet transmission in the contributor for the number of packets determined.

6. A method for generating a CID map comprising:
sorting SPTS rates of contributors in a table;
assigning a CID to an SPTS rate;
determining a fraction of MPTS for an SPTS rate;
determining a number of table entries for an SPTS rate based on the fraction;
determining an ideal distance between table entries for an SPTS rate based on the fraction; and
inserting the CID corresponding to the SPTS rate into the table based on the number of table entries and the ideal distance between table entries.

7. A method for back channel management comprising:
generating, by a null packet generator, a bitstream comprising null packets;
labeling the null packets with an address of the null packet generator;
receiving the bitstream by a contributor; and
transmitting, by the contributor, a message to the address of the null packet generator wherein the message comprises contributor data.

8. The method of claim 7, wherein the contributor data comprises a bit rate.

9. The method of claim 7, wherein the contributor data comprises a PMT PID and a program number.

10. The method of claim 8, wherein the null packet generator uses the bit rate information to create a CID Map.

11. The method of claim 9, wherein the null packet generator uses the PMT PID and program number to generate a Program Map table describing its audio and video streams and includes this PMT in the null packet generator SPTS output.

12. The method of claim 7, further comprising:
displaying, by the null packet generator, received contributor messages.

13. The method of claim 7, further comprising:
reporting, by the null packet generator, system configuration errors based on the received contributor messages.

14. A system for generating a multi-program transport stream comprising:
a null packet generator wherein the null packet generator generates a bitstream comprising null packets; and
a contributor operatively coupled to the null packet generator wherein the contributor receives the bitstream and replaces a null packet with a program packet.

15. The system of claim 14, wherein the null packet generator is a contributor.

16. An apparatus for generating a multi-program transport stream comprising:
a means for receiving a bitstream having a null packet;
a processor configured to identify packet transmission opportunities in the bitstream; and
a packet generator operatively coupled to the processor, wherein the packet generator is configured to replace a null packet in a received bitstream with a program packet when a packet transmission opportunity is identified by the processor.

17. A method for synching contributors comprising:
generating, by a first contributor, a first clock used at the first contributor's bitstream output to generate an output clock; and
deriving, by a second contributor, a second clock from the first contributor output clock.

18. A method for synching contributors comprising:
generating, by a first contributor, a first clock used at the first contributor's bitstream output to generate an output clock;
re-clocking, by a second contributor, the bitstream to a second clock internal to the second contributor; and
adjusting a stuffing byte character between bitstream packets.
